(19) United States
(12) Patent Application Publication
(10) Pub. No.: US 2026/0312079 A1
(43) Pub. Date: Oct. 8, 2026

(54) METHOD FOR MANUFACTURING A CATALYST LAYER, AND SUCH A LAYER, AS WELL AS A FUEL CELL MODULE, ASSEMBLY, POWER UNIT, AND VEHICLE INCORPORATING THE SAME

(71) Applicant: Aerostack GmbH, Dettingen an der Erms (DE)

(72) Inventors: Robert Alink, Dettingen an der Erms (DE); Nuno Sousa, Dettingen an der Erms (DE)

(21) Appl. No.: 19/576,061

(22) Filed: Mar. 24, 2026

(30) Foreign Application Priority Data
Mar. 27, 2025 (DE) 102025111916.3

(51) Int. Cl. H01M 4/88; B64D 37/00

(52) U.S. Cl. CPC H01M 4/881; B64D 37/00; H01M 2250/20

(57) ABSTRACT

A method for manufacturing catalyst layers for fuel cell elements of a fuel cell module, a catalyst-coated membrane for fuel cell elements of a fuel cell module, a fuel cell assembly with a corresponding fuel cell module, a propulsion unit for a vehicle, in particular an aircraft, with a corresponding fuel cell assembly, and a corresponding vehicle, in particular an aircraft. The method includes providing a substrate structure with micro-openings and at least partially filling the micro-openings with a catalyst mixture comprising an ionomer and a catalytic component.

### TECHNICAL FIELD

The present disclosure relates to a method for manufacturing a catalyst layer for fuel cell elements of a fuel cell module, a catalyst-coated membrane, a fuel cell module for a fuel cell assembly, a fuel cell assembly for a vehicle, a propelling unit for a vehicle, and a vehicle, in particular an aircraft.

### BACKGROUND

Vehicles with fuel cells and corresponding fuel cell modules or stacks are known from the prior art. For example, proton exchange membrane fuel cells (PEMFCs) bipolar plates with gas flow channels (so-called flow field channels), which guide the fuel as a reducing agent on one side and, as a rule, atmospheric oxygen as an oxidizing agent on the other side through a gas diffusion layer (GDL) to an anode or cathode of the fuel cell. A proton-conducting membrane is positioned between the anode and cathode, through which protons derived from hydrogen migrate from the anode to the cathode to generate a usable electrical potential via the electrons separated by them. This structure of a fuel cell, comprising bipolar plates, a gas diffusion layer, and a proton-conducting membrane, is repeated in a stack configuration to electrically connect the cells in series, thereby providing the aforementioned fuel cell modules or stacks.

The proton-conducting catalyst-coated membrane comprises a membrane and catalyst layers or coatings containing a catalyst, typically platinum. The catalyst may, for example, be supported or bound to carbonblack. As a core element, the catalyst layer enables the electrochemical reactions occurring in the fuel cell, in particular the transport of protons, gas, and electrons for the generation of electrical energy. The specific structure of the catalyst layer, which typically comprises an ionomer and a catalyst applied to an electrically conductive support, thus determines various concurrent transport phenomena and influences the overall activity or electrical performance, as well as the stability and service life of the fuel cell.

Catalyst layers are generally produced by formulating an ink containing a catalyst powder, dissolved ionomer, and solvent. The ink is applied either to a substrate or directly to a membrane, after which a porous matrix consisting of ionomer, catalyst, and catalyst support is formed during a drying step. The ionomer is embedded between the catalyst particles in the form of a film several nanometers thick, thereby creating ionic conductivity between the active sites in the catalyst layer.

Alink, Robert; Rajveer Singh; Patrick Schneider; Kläre Christmann, Johannes Schall, Roman Keding, and Nada Zamel; "Full Parametric Study of the Influence of Ionomer Content, Catalyst Loading and Catalyst Type on Oxygen and Ion Transport in PEM Fuel Cell Catalyst Layers", Molecules 25, no. 7: 1523; 2020; https://doi.org/10.3390/molecules25071523 focus on material development for polymer electrolyte membrane fuel cells, particularly the membrane-electrode assembly, where it has been shown that the structuring of its various layers is directly related to performance enhancement. They investigate the influence of various components in the cathode catalyst layer, such as ionomer content, catalyst loading, and catalyst type, on oxygen and ion transport using a comprehensive parametric analysis. When using two catalyst types, 40 wt% Pt/C and 60 wt% Pt/C with high-surface-area carbon, the ionomer/carbon content was varied between 0.29 and 1.67, while the Pt loading was varied in the range of 0.05 to 0.8 mg cm⁻². It was found that the optimal ionomer content depends on the operating point and conditions, as well as on the catalyst loading and type.

Alternative hydrogen-based propulsion systems are also currently being developed for vehicles, including aircraft, to replace fossil fuels and mitigate their environmental impact. Fuel cells in vehicles, such as aircraft, can utilize hydrogen for propulsion and for power generation in Auxiliary Power Units(APUs). The use of hydrogen, in particular, is seen as a path toward environmentally friendly and sustainable aviation, as it can prevent the release of carbon dioxide or other hydrocarbon-related emissions.

US 7,837,819 B2 relates to a method for manufacturing a membrane-electrode assembly (– MEA) for a fuel cell, in which a binder is sprayed onto the surface of a polymer film, a catalyst slurry is applied to the surface of an electrolyte membrane by rod coating and bonded to the binder to form a catalyst electrode layer, a bonded unit comprising the electrolyte membrane and the catalyst electrode layer is separated from the polymer film after a drying process to obtain a two-layer MEA, and the two-layer MEAs thus obtained are used to form a three-layer MEA or a five-layer MEA via a hot-pressing process. Accordingly, catalyst loss is intended to be minimized, since the catalyst slurry is sprayed directly onto the membrane and the catalyst electrode layer is hot-pressed in a solid state onto both surfaces of the membrane.

DE10 2006 002470 A1 describes a fuel cell system for supplying a vehicle with drinking water and oxygen, which fuel cell system comprises a fuel cell and an electrolysis cell with an air cathode. Furthermore, the electrolysis cell is coupled to the fuel cell, and the fuel cell and the electrolysis cell are configured such that the power demand of the electrolysis cell is fully covered by the power output of the fuel cell.

In fuel cell arrangements known from the prior art, there is potential for improvement in terms of weight reduction and miniaturization or increasing their gravimetric power density: To achieve this, the electrical current density of the individual fuel cell elements can be increased. A problem is that as the thickness of the catalyst layer increases, losses in mass transport and charge transport across the thickness of the catalyst layers increase significantly.

In general, the performance and efficiency of the fuel cell increase with the addition of catalyst material; however, the current density no longer rises beyond a catalyst loading threshold of approximately 0.4 mg of platinum per ^{cm²} for the catalyst layers. Beyond this point, protons can no longer be efficiently transported to regions more than 10 µm away from the polymer membrane. As a rule, therefore, the performance of the fuel cell does not increase significantly beyond a catalyst loading of 0.4 mg cm⁻², which corresponds to a thickness of about 10 µm. To improve proton conductivity, a higher ionomer content can be added to a catalyst mixture, such as a catalyst ink; however, this in turn blocks oxygen transport by increasing the ionomer film thickness near the catalyst particles, thereby limiting fuel conversion and thus the current density. An important optimization parameter for catalyst layers therefore lies in balancing oxygen and proton transport losses by adjusting the ionomer content in the catalyst layers.

### SUMMARY

It can be considered to be an object to provide fuel cell modules with the lowest possible weight and/or space requirements, or the highest possible gravimetric power density, without compromising their manufacturing and operational characteristics. In particular, it can be considered an object to provide fuel cell modules with the highest possible current density. This task is solved by the subject matter disclosed herein.

Further embodiments are described in the following description. Features described in relation to methods for providing fuel cell modules, as well as corresponding method steps, may be implemented as device features, or vice versa. Sections of the description relating to the method therefore apply analogously to a manufacturing apparatus for catalyst coatings, layers, and/or catalyst-coated membranes or fuel cell modules, as well as to computer programs for controlling them. In particular, method steps and components mentioned in connection therewith may be implemented as functions of a manufacturing device and corresponding computer programs, and any functions of the manufacturing device may be implemented as method steps.

In particular, the object is solved by a method for manufacturing a catalyst layer for fuel cell elements of a fuel cell module, comprising the following steps: providing a substrate structure with micro-openings and at least partially filling the micro-openings with a catalyst mixture comprising an ionomer and a catalytic component.

In the case of a catalyst-coated membrane for fuel cell elements of a fuel cell module, the object is solved wherein the catalyst-coated membrane is provided with, or comprises, a catalyst layer produced by a corresponding method, at least in sections.

In a fuel cell module for a fuel cell assembly, comprising at least one fuel cell element, the object is solved in that the at least one fuel cell element comprises a corresponding catalyst layer and/or a catalyst-coated membrane.

In a fuel cell assembly for a vehicle , in particular an aircraft, the object is solved in that the fuel cell assembly comprises at least one corresponding fuel cell module.

In a propulsion unit for a vehicle, in particular an aircraft, the object is solved in that the propulsion unit comprises at least one corresponding fuel cell assembly.

In a vehicle, particularly an aircraft, the object is accomplished by a corresponding fuel cell module and/or a corresponding propulsion unit.

The solution according to the disclosure herein thus provides catalyst layers and/or coatings for catalyst-coated membranes, as well as potentially other layers of fuel cells—such as gas diffusion layers with catalyst layers or gas diffusion electrodes—based on substrate structures with micro-openings that are filled with the catalyst mixture (catalyst and ionomer). The substrate structure provides voids that can extend individually or collectively from one side of the substrate structure or the catalyst layer formed therefrom to the other. Arranging the catalyst mixture within these voids enables the separation of proton transport: over short distances via a type of ionomer film near the catalyst particles, and over long distances through the creation of proton conduction channels that act as “proton transport highways” which, similar to the capillary effect, efficiently transport the protons through the entire thickness of the catalyst layer in the best case.

Such a solution thus helps to improve mass transfer, particularly the transport of protons through the catalyst layer. This makes it possible, in particular, to provide efficient catalyst layers with relatively high thickness, which exhibit significantly increased efficiency. This allows for an increase in fuel turnover and, consequently, in the current density within the individual fuel cell elements, which ultimately leads to an increase in the gravimetric power density of the fuel cell modules. The solution offers a number of advantages over the prior art by enabling the reproducible manufacture of fuel cell modules with high gravimetric power density and stable operating characteristics.

According to an embodiment the micro-openings may be configured such that they are formed, at least in sections, as elongated paths that extend through the substrate structure substantially perpendicular to a planar extension plane thereof. In other words, an arrangement of the proton-conducting “proton transport highways” in the direction of the thickness of the catalyst layer is advantageous. Such elongated paths can be formed by a porous and/or fibrous structure in which the catalyst mixture is incorporated. Alternatively or additionally, the paths may be formed, at least in sections, as capillaries. Thus, proton pathways aligned essentially perpendicular to the membrane can be achieved, which enable efficient transport of protons from the membrane to the catalytically active centers. The porous and/or fibrous structures can be designed such that effective proton conduction is achieved without occupying an excessive amount of volume for the catalytically active component.

According to an embodiment, the micro-openings may be configured such that they are formed as pores at least in sections. Such pores may be filled with catalytically active material, serve as effective gas transport pathways and/or as openings to the proton conduction channels, or form these at least in sections. This helps to further improve proton and gas transport through the catalyst layers.

According to an embodiment, the layer thickness of the substrate structure may be between 5 and 100 μm and/or the opening diameter of the micro-openings may be between 1 and 30 μm. The substrate structure can thus be provided as a structural element of a catalyst layer with a corresponding layer thickness. The micro-openings with a corresponding opening diameter allow the catalyst mixture to be absorbed into the substrate structure.

According to an embodiment, the volume ratio between the substrate structure and the micro-openings may be between 10 and 95%, for example between 40 and 90%. In this way, the ionomer and catalyst content of the catalyst layer can be optimized, thereby minimizing oxygen and proton transport losses through the catalyst layer. This allows the fuel conversion and thus the current density in the individual fuel cell elements to be further increased, leading to an increase in the gravimetric power density of the fuel cell modules.

### BRIEF DESCRIPTION OF THE DRAWINGS

Some details are described in more detail below with reference to the attached drawings. The illustrations are schematic and not to scale. Identical reference symbols refer to the same or similar elements. They show:

FIG. 1 a schematic top view of an embodiment of a vehicle in the form of an aircraft; and

FIG. 2 a schematic front view of an embodiment of a fuel cell module of the vehicle shown in FIG. 1.

FIG. 3 aschematic front view of an embodiment of a catalyst-coated membrane of a fuel cell element of the fuel cell module shown in FIG. 2.

FIG. 4 a schematic front view of detail III shown in FIG. 3 of an embodiment of a catalyst layer of the catalyst-coated membrane.

FIG. 5 a schematic front view of detail III shown in FIG. 3 of a further embodiment of a catalyst layer of the catalyst-coated membrane.

FIG. 6 a schematic sequence of possible steps in a method for manufacturing a catalyst layer of the catalyst-coated membrane.

### DETAILED DESCRIPTION

The following detailed description is merely illustrative and is not intended to limit the disclosure herein or its possible applications. Furthermore, there is no intention to be bound by what is set forth in the preceding background or in the following detailed description. The representations and illustrations in the drawings are schematic and not to scale. Identical elements are generally designated by the same names and assigned the same reference numerals. A better understanding of the described subject matter can be obtained by considering the illustrations together with their detailed description.

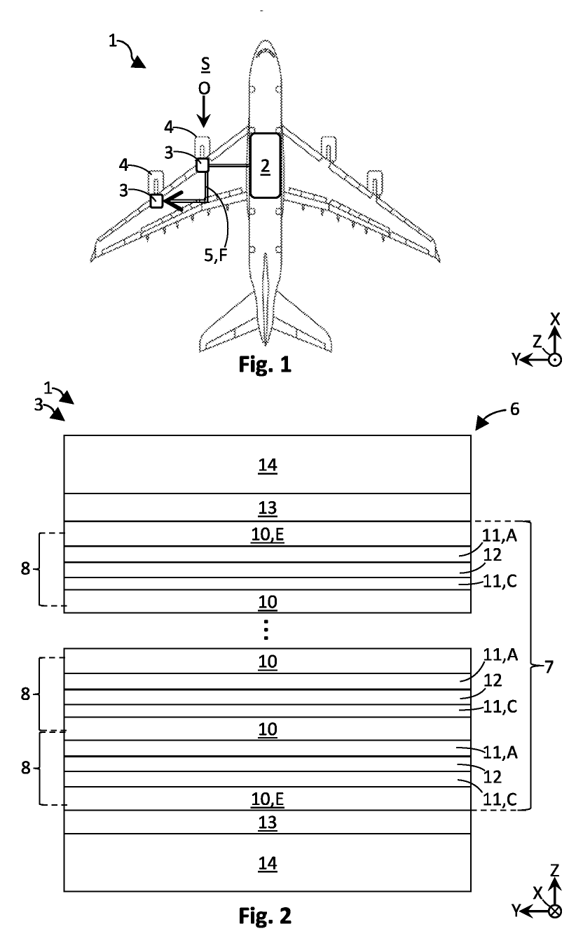

FIG. 1 shows a schematic top view of an example embodiment of a vehicle 1 in the form of an aircraft. The vehicle 1 comprises a fuel reservoir 2, fuel cell assemblies 3, and propulsion units 4. From the fuel reservoir 2, for example a tank, a reducing gas F or fuel, such as hydrogen, is supplied via gas lines 5 to the fuel cell assemblies 3, which generate electrical energy during the conversion of the reducing gas F with an oxidizing gas O, such as air drawn from the atmosphere S surrounding the vehicle, which in turn is supplied to the propulsion units 4 to propel the vehicle. The vehicle 1 extends in a longitudinal direction X, a transverse direction Y, and a height direction Z, which together define a Cartesian coordinate system.

FIG. 2 shows a schematic front view of a fuel cell module 6 of the vehicle 1 shown in FIG. 1. As part of the fuel cell assemblies 3, the fuel cell module 6 comprises a cell row assembly (CRA) 7, also known as a Cell Stack, which comprises a row of fuel cell elements 8 or individual cell assemblies. Each fuel cell element 8 comprises a bipolar plate 10, two gas diffusion layers 11, and a catalyst-coated membrane 12.

The bipolar plates 10 are each sandwiched between the two gas diffusion layers 11, namely an anode-side A gas diffusion layer 11 and a cathode-side C gas diffusion layer 11. In the present embodiment, the catalyst-coated membrane 12—for example, in the form of a catalyst- and ionomer-coated membrane (CCM)—is arranged between the gas diffusion layers 11 of two adjacent fuel cell elements 8. A bipolar plate 10 or end plate, each forming an end side E, closes off the cell stack 7.

Current collectors 13 of the fuel cell module 6 are positioned on the outer side of the end-side E bipolar plates 10 to collect the electrical current generated by the cell stack 7 during the conversion of the reducing gas F and the oxidizing gas O. In turn, an end plate 14 of the fuel cell module 6 is in contact with the outside of each current collector 13, electrically isolating the cell stack 7 from the outside. The cell stack 7 thus typically comprises a number of fuel cell elements 8 with bipolar plates 10, gas diffusion layers 11, and catalyst-coated membranes 12, wherein the number of cell stack groups 7 may, for example, range from 300 to 500, such as approximately 400, in order to provide a required total electrical voltage through corresponding voltage summation.

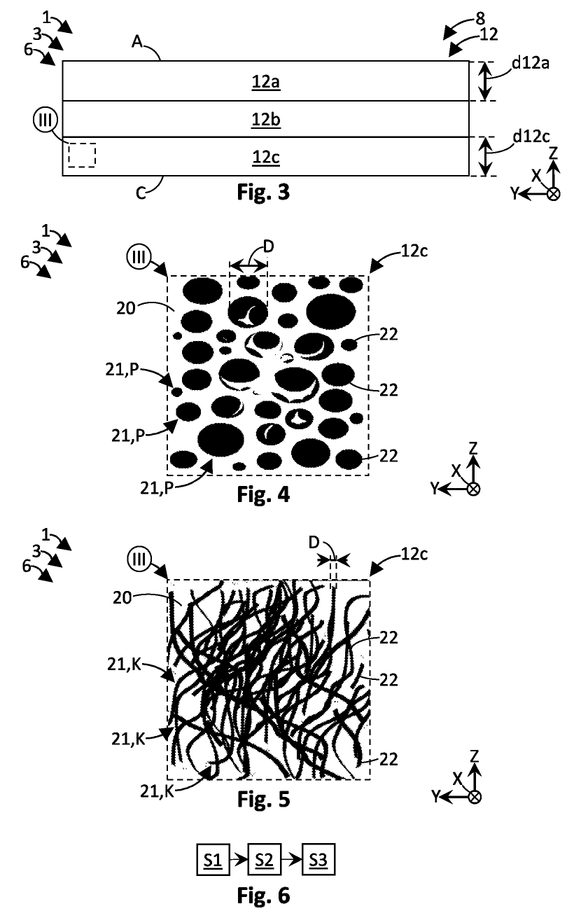

FIG. 3 shows a schematic front view of an embodiment of one of the catalyst-coated membranes 12 of one of the fuel cell elements 8 of the fuel cell module 6 shown in FIG. 2. The catalyst-coated membrane 12 comprises an anode-side catalyst layer 12a, a membrane 12b, such as a polymer electrolyte membrane (PEM), for example made of an ionomer such as Nafion or the like, and a cathode-side catalyst layer 12c. The catalyst layers 12a, 12c may, for example, each have an anode-side layer thickness d12a measured substantially parallel to the height direction Z and a cathode-side layer thickness 12b of 5 to 100 μm.

FIG. 4 shows a schematic front view of detail III shown in FIG. 3 of an embodiment of a cathode-side C catalyst layer 12c of the catalyst-coated membrane 12, wherein this may also be a cross-sectional view. The catalyst layer comprises a substrate structure 20 having micro-openings 21, here for example in the form of pores P, which, when connected to one another, can form paths that penetrate the catalyst layer 12c substantially along the height direction Z. The micro-openings 21 are filled with a catalyst mixture 22 comprising an ionomer and a catalytic component, such as platinum, and may have an opening diameter D of 1 to 30 μm.

FIG. 5 shows a schematic front view of a detail III shown in FIG. 3 of a further embodiment of a cathode-side catalyst layer 12c of the catalyst-coated membrane 12, wherein this may also be a cross-sectional view. The substrate structure 20 has micro-openings 21, here for example in the form of capillaries K and/or interstices that may be formed between fiber elements, and which may form paths that penetrate the catalyst layer 12c substantially along the height direction Z. The micro-openings 21 are filled with the catalyst mixture 22, which comprises an ionomer and a catalytic component, for example platinum, and may have an opening diameter D of 1 to 30 μm.

FIG. 6 shows a schematic sequence of possible steps in a method for manufacturing a catalyst layer 12a, 12c, for example for the catalyst-coated membrane 12. In a first step S1, the substrate structure 20 with the micro-openings 21 can be provided, for example as a porous, relatively rigid ionomer structure, which can be produced in various ways, e.g., by electrospinning, casting with pore fillers, as a membrane with high roughness, large surface area, etc. In a second step S2, the substrate structure 20, including the micro-openings 21, can be provided with the catalyst mixture 22, in particular filled and/or coated, for example with a catalyst ink comprising a catalyst in dispersion with ionomer and various solvents such as alcohols or water.

In a third step S3, the filled and/or coated substrate structure 20 can be dried. In doing so, the catalyst or the catalytic component can be mechanically and protonically bonded to the substrate structure 20, for example a porous ionomer structure. Thus, a catalyst layer 12a, 12c can be provided that contains a mesoscopic ionomer network (porous network) in which a catalyst layer with a composition corresponding to the respective requirements is embedded at least in sections, for example in the form of a supported catalyst with microscopic ionomer structures. Steps S1 through S3 may be repeated as needed to further increase the degree of filling of the porous structure with the catalyst mixture 22 after drying.

It should also be noted that “comprising” or “having” does not exclude other elements or steps, and “a” or “an” does not exclude a plurality. Furthermore, it should be noted that features or steps described with reference to one of the above embodiments may also be used in combination with other features or steps of other embodiments described above. Reference numerals in the claims are not to be construed as limiting.

### LIST OF REFERENCE SYMBOLS

1 Vehicle / Aircraft
2 Fuel reservoir / Tank
3 Fuel cell assembly
4 Propelling unit
5 Fuel line
6 Fuel cell module
7 Cell stack
8 Fuel cell element / cell assembly
10 Bipolar plate
11 Gas diffusion layer
12 Catalyst-coated membrane / Membrane-catalyst layer unit
12a Anode-side catalyst layer
12b Membrane
12c Cathode-side catalyst layer
13 Current collector
14 End plate
20 Substrate structure
21 Micro-openings
22 Catalyst mixture
d₁₂ₐThickness of the anode side catalyst layer
d_{12b}Thickness of the cathode-side catalyst layer
A Anode side
C Cathode side
D Opening diameter of micro-openings
E End side/end plate
F Reduction gas / Fuel
K Capillary
O Oxidizing gas
P Pore
S Atmosphere/Environment
X Longitudinal direction
Y Transverse direction
Z Height direction
S1 Providing substrate structure
S2 Application of catalyst mixture
S3 Drying

1. A method for manufacturing a catalyst layer for fuel cell elements of a fuel cell module, the method comprising:
providing a substrate structure with micro-openings; and
at least partially filling the micro-openings with a catalyst mixture comprising an ionomer and a catalytic component.

2. The method according to claim 1, wherein the micro-openings are formed, at least in sections, as elongated paths that extend through the substrate structure substantially perpendicular to a planar extension plane thereof.

3. The method according to claim 1, wherein the micro-openings are formed, at least in sections, as pores.

4. The method according to claim 1, wherein a layer thickness of the substrate structure is between 5 and 100 μm and/or an opening diameter of the micro-openings is between 1 and 30 μm.

5. The method according to claim 1, wherein a volume ratio between the substrate structure and the micro-openings is between 40 and 90%.

6. A catalyst-coated membrane for fuel cell elements of a fuel cell module, wherein the catalyst-coated membrane comprises a catalyst layer manufactured, at least in sections, by the method according to claim 1.

7. A fuel cell module for a fuel cell assembly, comprising at least one fuel cell element, wherein the at least one fuel cell element comprises a catalyst layer manufactured at least in sections by the method according to claim 1.

8. A fuel cell module for a fuel cell assembly, comprising at least one fuel cell element, wherein the at least one fuel cell element comprises the catalyst-coated membrane according to claim 6.

9. A fuel cell assembly for a vehicle or an aircraft, wherein the fuel cell assembly comprises at least one fuel cell module according to claim 1.

10. A propulsion unit for a vehicle or an aircraft, wherein the propulsion unit comprises at least one fuel cell assembly according to claim 9.

11. A vehicle or an aircraft, comprising at least one fuel cell assembly according to claim 9.

12. A vehicle or an aircraft, comprising a propulsion unit according to claim 10.
